(19) United States
(12) Patent Application Publication
(10) Pub. No.: US 2009/0007457 A1
(43) Pub. Date: Jan. 8, 2009

(54) SHOES

(76) Inventor: Simon Jeremy Skirrow, Queensland (AU)

Correspondence Address: YOUNG & THOMPSON, 209 Madison Street, Suite 500, ALEXANDRIA, VA, 22314, US

(21) Appl. No.: 10/578,363

(22) PCT Filed: Nov. 5, 2004
(86) PCT No.: PCT/AU2004/001545

§ 371 Date: Sep. 15, 2008

(30) Foreign Application Priority Data
Nov. 7, 2003 (AU) 2003906140
May 31, 2004 (AU) 2004902849

(51) Int. Cl. A43B 5/00; B32B 9/04; B32B 27/00; B32B 27/40; B32B 27/36; B32B 7/12

(52) U.S. Cl. 36/133; 36/114; 428/446; 428/500; 428/704; 428/423.1; 428/480; 428/354

(57) ABSTRACT

A shoe (1) in which at least a portion of upper (1a) includes gripping areas (4, 5) resulting from the presence of a coating, the coating providing a dry coefficient of friction exceeding that of a standard athletic leather according to a modified IUP51 test (as defined).

### FIELD OF INVENTION

The present invention applies preferentially to sports shoes and describes methods for increasing the grip of the outer surface of the shoe upper when dry but also improving all round performance.

### BACKGROUND DESCRIPTION

The present inventor has investigated improving grip on the upper of sports shoes. In particular this includes dry grip characteristics, though consideration is also given to grip characteristics when wet or damp. In terms of shoe performance, as will be discussed below, improving grip over standard construction materials such as athletic leather is important. Most users, professional or novice, improved grip can improve accuracy and effectiveness for ball sports such as soccer—especially when kicking or dribbling a ball.

Accordingly the performance of both dry, but especially damp, shoes is a very real problem. The performance of standard athletic leathers has been a limiting factor in improving the performance characteristics of sports shoes, though no viable commercial solution has previously been invented or taken off. The direction of the prior art in addressing the performance of shoe outer materials has, in the past, focused on texturing processes to roughen the surface of materials used. This provides only a limited improvement in grip performance. Another alternative was to introduce raised features which increase water drainage as well as acting as physical raised surfaces which theoretically grip better. Examples include the rubber projections of Brutting (U.S. Pat. No. 3,191,321) and the formations of Johnson (U.S. Pat. No. 5,437,112). However these modifications can significantly affect the nature of the shoe's outer surface, which interferes with the ‘feel’ and feedback that a soccer player (for instance) may experience when using the shoe. Such characteristics are important to a player's performance, and hence such solutions to grip introduce their own set of problems.

The use of exotic materials such as sharkskin have also been reported (WO0307745) though all these modifications provide only marginal and barely acceptable wet grip improvements, and with a significant cost to manufacturing ease, cost, and flexibility. The direction that the prior art is heading has thus failed to produce anything of outstanding or significantly improved quality that satisfies player's and manufacturer's needs alike for an all round sports shoe which may be used in the wet, as well as dry.

As previously indicated, a boot of standard athletic leather will typically perform poorly when wet, but quite a bit better when dry. Surface water layers tend to cause balls to hydroplane, or behave unpredictably—often sliding or spinning across the surface of the boot. The result is a significant loss in precision and accuracy.

The performance of a shoe is very important for both those learning a game, who train not only in the dry but also in the wet, as well as for the professional player—though their skill may compensate for shortcomings in a shoe's design. The exact qualities for a shoe are difficult to quantify, and are rather subjective, including factors such as: robustness, compliance in terms of feel and touch, and good shoe form and shape. At the end of the day the player is looking for relative consistency of performance under different conditions, as well as accuracy, and hence a shoe with relatively consistent properties when wet or dry is of value.

To the manufacturer, there is a need for an improved material for shoe outer construction which possesses many of the desirable qualities of materials such as athletic leather, such as durability, and the right blend of robustness and flexibility. There is also a need for an alternative which preserves or improves player-subjective characteristics such as feel and feedback. Quite importantly, there is also a need for an alternative which does not require substantial modification, or a departure from, existing shoe manufacturing processes—such changes may be expensive to implement and render any such alternative uneconomical.

To date, to the best knowledge of the inventor, no such alternatives or solutions exist which address a majority of these needs and desires. Accordingly the inventor has proceeded to investigate various inventive options for addressing these problems and needs.

It is therefore one object of the present invention to address these considerations.

It is a further object of the present invention to provide a material for use in the construction of a shoe, a shoe, or means for modifying a shoe, which provides improved gripping characteristics (for on at least part of the upper of a shoe) when dry when compared to standard athletic leathers.

Preferably it is also an object to provide a sports shoe having relatively consistent performance when wet or dry.

At the very least it is an object of the present invention to provide the public with a useful alternative choice.

Aspects of the present invention will be described by way of example only and with reference to the ensuing description.

### GENERAL DESCRIPTION OF THE INVENTION

According to one aspect of the present invention there is provided a shoe, in which at least a portion of the upper includes gripping areas resulting from the presence of a coating, said coating providing a dry co-efficient of friction exceeding that of standard athletic leather according to the modified IUP51 test defined herein.

According to a further aspect of the present invention there is provided a material, suitable for use in the construction of the upper of a shoe, which is at least partially coated with a coating providing a dry co-efficient of friction exceeding that of standard athletic leather according to the modified IUP51 test defined herein.

According to a further aspect of the present invention there is provided a patch for application to the upper of a shoe, said patch providing at least one surface at least partially coated with a coating providing a dry co-efficient of friction exceeding that of standard athletic leather according to the modified IUP51 test defined herein.

According to another aspect of the present invention there is provided a shoe, material, or patch, substantially as described above, in which said coating comprises a liquid silicone rubber coating.

According to another aspect of the present invention there is provided a shoe, material, or patch, substantially as described above, in which said coating comprises a highly plasticised coating.

According to another aspect of the present invention there is provided a shoe, material, or patch, substantially as described above, in which said coating is based on a PVC homopolymer or PVC/PVA copolymer.

According to another aspect of the present invention there is provided a shoe, material, or patch, substantially as described above, in which there is included a plasticiser from the group comprising: Dialkyl adipate esters, dialkyl azelates, glycol dibenzoate esters, glycollates such as butyl phthalyl, butyl glycollate, mellitates such as trialkyl trimellitates, a few phenoxy compounds, phosphate esters including triaryl, trialkyl and alkyl-aryl combinations, derivatives of ortho-phthalic acid with emphasis on dialkyl and alkyl benzyl o-phthalates, polyesters and various dibasic acids with glycols (e.g., adipic, azelaic and phthalic acids with various glycols terminated with a monofunctional compound), pentaerythritol derivatives and sulfonamides.

According to another aspect of the present invention there is provided a shoe, material, or patch, substantially as described above, in which there is included a secondary plasticiser from the group comprising: aromatic and mixed aromatics aliphatic oils, chlorinated paraffins, poly-alpha methylstyrene derivatives and esters of high molecular weight alcohols and organic acids, which have marginal compatibility with PVC, monomeric esters of straight chain dibasic acids, certain epoxy derivatives including epoxidized soybean oil, epoxidized tall oil and some epoxy resins.

According to another aspect of the present invention there is provided a shoe, material, or patch, substantially as described above, in which the amount of plasticiser(s) present is 65% or more by weight compared to the polymer or co-polymer.

According to another aspect of the present invention there is provided a shoe, material, or patch, substantially as described above, in which the amount of plasticiser(s) present is 66±4% by weight compared to the polymer or co-polymer.

According to another aspect of the present invention there is provided a shoe, material, or patch, substantially as described above, which includes a mineral stearate dispersed in an epoxidised soya oil.

According to another aspect of the present invention there is provided a shoe, material, or patch, substantially as described above, which includes a polyisobutylene.

According to another aspect of the present invention there is provided a shoe, material, or patch, substantially as described above, which either or both, include or are at least partially coated with a particulate material.

According to another aspect of the present invention there is provided a shoe, material, or patch as claimed in any one of claims 1 through 3 which are at least partially coated with a coating which either or both includes a particulate material, or has had a particulate material applied.

According to another aspect of the present invention there is provided a shoe, material, or patch, substantially as described above, in which the coating includes either or both an aqueous aliphatic polyurethane dispersion and aqueous aliphatic acrylic dispersion.

According to another aspect of the present invention there is provided a shoe, material, or patch, substantially as described above, which includes a cross-linking agent.

According to another aspect of the present invention there is provided a shoe, material, or patch, substantially as described above, in which the cross-linking agent is an isocyanate.

According to another aspect of the present invention there is provided a shoe, material, or patch, substantially as described above, in which the particulate material includes a mineral.

According to another aspect of the present invention there is provided a shoe, material, or patch, substantially as described above, in which the mineral is selected from the group comprising: aluminium oxides, tungsten carbide, silicon carbide, cubic boron nitride, ceramic materials, garnet, a Trizact® abrasive from 3M, and diamond particulates.

According to another aspect of the present invention there is provided a shoe, material, or patch, substantially as described above, in which the particulate material includes a synthetic plastic material in a particulate or granular form.

According to another aspect of the present invention there is provided a shoe, material, or patch, substantially as described above, in which the hardness of included plastic particles equals or exceeds a hardness of 75 Shore A.

According to another aspect of the present invention there is provided a shoe, material, or patch, substantially as described above, in which the particulate material comprise a crumbed rubber.

According to another aspect of the present invention there is provided a shoe, material, or patch as claimed in any one of claims 12 through 21 in which said particulate material includes particles in the size range of 0.5-100 microns inclusive.

According to another aspect of the present invention there is provided a shoe, material, or patch, substantially as described above, when a said coating is applied to a leather material.

According to another aspect of the present invention there is provided a shoe, material, or patch, substantially as described above, in which the leather is goat or kangaroo leather. According to another aspect of the present invention there is provided a shoe, material, or patch, substantially as described above, when a said coating is applied to a fabric or textile.

According to another aspect of the present invention there is provided a shoe, material, or patch, substantially as described above, in which the fabric or textile is, or includes, Kevlar.

According to another aspect of the present invention there is provided a shoe, material, or patch, substantially as described above, in which a said coating has been applied in a pattern.

According to another aspect of the present invention there is provided a shoe, material, or patch, substantially as described above, in which the pattern comprises one or more of: logos, advertising material, graphics, text, alphanumeric characters, repetitive patterns or arrangements.

According to another aspect of the present invention there is provided a shoe, material, or patch, substantially as described above, which includes areas comprising different of said coatings.

According to another aspect of the present invention there is provided a shoe, material, or patch, substantially as described above, which includes an area of a the hook and pile material Greptile G200 by 3M.

According to another aspect of the present invention there is provided a patch, substantially as described above, which includes a self-adhesive layer.

According to a further aspect of the present invention there is provided a sports shoe in which at least part of the upper in the toe area possesses a coating of a grip enhancing agent which increases the dry coefficient of friction, when compared to standard athletic leather when measured by a modified IUP51 test as defined herein, said grip enhancing agent being selected from the group comprising: liquid silicone rubbers, PVC polymers with high plasticiser contents, PVC/PVA copolymers with high plasticiser contents, urethane resins with high plasticiser contents, acrylic resins with high plasticiser contents, urethane/acrylic blends or hybrids with high plasticiser contents, particulate materials in combination with previously listed members of this group, and particulate materials in combination with acrylic and/or polyurethane binders.

According to a further aspect of the present invention there is provided a patch suitable for attachment to a shoe in which at least part of the upper in the toe area possesses a coating of a grip enhancing agent which increases the dry coefficient of friction, when compared to standard athletic leather when measured by a modified IUP51 test as defined herein, said grip enhancing agent being selected from the group comprising: liquid silicone rubbers, PVC polymers with high plasticiser contents, PVC/PVA copolymers with high plasticiser contents, urethane resins with high plasticiser contents, acrylic resins with high plasticiser contents, urethane/acrylic blends or hybrids with high plasticiser contents, particulate materials in combination with previously listed members of this group, and particulate materials in combination with acrylic and/or polyurethane binders.

According to a further aspect of the present invention there is provided a shoe in which at least part of the upper is coated with a coating substantially as described herein and with reference to the contained examples.

The present invention has a number of aspects, including the preparation of materials with improved (with respect to standard athletic leather) grip properties for use in shoe manufacture, sports shoes with enhanced grip characteristics, and modifications to sports shoes to improve their grip characteristics. Typically a sports shoe in the present invention shall be a shoe such as used in ball sports. For simplicity of description, the majority of the description herein shall be made in the context of a shoe though it should be appreciated that many of the principles discussed herein are applicable to materials for use in manufacture of a shoe.

It has been discussed that a common problem with typical sports shoes, such as soccer boots, is that they become slippery when wet. This significantly reduces the accuracy of a player kicking the ball as the ball can slide, glance, or spin across the surface of the boot—depending on the exact dynamics of the impact. Similarly, poor dry grip also introduces problems, and thus an improvement over standard athletic leather is sought. Relative consistency between wet and dry performance is also desirable.

The present invention introduces means for improving the wet and dry grip characteristics (compared to standard athletic leather) across the entire upper, or part of the upper, of a shoe. In this context this comprises at the very least improving the wet and dry grip characteristics relative to standard leather and standard imitation leather materials commonly used for sports shoes.

As a measure of this performance the coefficient of friction, when a modified IUP51 test procedure (see below) designated by the International Union of Leather Technologists and Chemists is used. Preferably, enhanced shoes and materials for use in shoe outers possess a coefficient of friction which equals or exceeds a value of 2.0 when dry and 1.5 when wet. In an ideal material, the coefficient of friction when wet is approximately the same as the coefficient of friction when dry. The modified IUP51 test is based on the standard test using a PTFE reference bed, but where this is modified to be a material, either natural or synthetic, with a polyurethane coating as used in soccer ball production.

The utilisation of gripping areas with improved grip characteristics on the upper of a sports shoe can significantly improve the kicking and ball manipulating characteristics when the shoe is wet or dry, also often paralleling or exceeding the subjective performance characteristics of a comparable boot of standard leather construction when wet or dry. This has the potential to provide a significant improvement in a player's game, particularly for amateur or novice players whose skills may be inadequate to compensate for standard wet boots, or to compensate for changes in the characteristics in a standard boot between wet and dry.

A preferred material for construction of the upper of a shoe according to the present invention is a substrate, treated with a suitable coating, or to utilise a microhook or micropile fabric. Both variations allow for standard shoe manufacturing processes to be used without significant modification. Both also avoid significant changes in the flexibility of a shoes outer, such as can be evident in the prior art examples previously discussed, thus preserving many attributes considered desirable by players. This is important, as the subjective feel and feedback of a boot has a significant bearing on its acceptance at both professional and market level.

The coating processes of the present invention are desirable in that they may be applied either pre- or post-shoe production. For simplicity of description, the majority of the description given herein will be given in relation to preparation of a modified material for use in the manufacture of a shoe, though the principles should be extended to processes applying coatings to a fully or partially constructed shoe. The latter options may provide some additional advantages, particularly when short runs of specialised coatings (e.g. a specific team colour, or a printed coating application pattern) are to be applied.

There are a number of preferred coatings, suitable for the manufacture of a sports shoe, according to the present invention. Some of these may be further modified, all as discussed below. These coatings are applied to a substrate, which in most cases will comprise a suitable natural or synthetic material. Preferred materials include leathers, and particularly cow, goat, and kangaroo leathers—but not restricted thereto. Synthetic leathers and materials commonly used in sports shoe manufacture may also be used.

The surface of the substrate material may be modified prior to the application of a coating to increase its adhesion or performance. Options include, but are not restricted to one or more of: scoring, buffing, or roughening of the surface; the application of primers.

Typically one or more coatings, according to the present invention, are then applied though at least partial shoe construction may occur prior to application of final grip enhancing materials according to some embodiments of the present invention.

The work of the inventor have identified a number of coating materials that may be applied to a suitable substrate, which are suitable for the construction of a sports shoe with desirable properties. Each can provide relatively consistent wet and dry performance, as is desirable. Each also allows substantially standard sports shoe manufacturing processes to be used with little or no modification. In accordance with these attributes the present invention includes a grip enhancing coating from the group of desired coatings comprising: a liquid silicone rubber coating, a highly plasticised coating, a synthetic rubber coating in conjunction with a solid particulate material, or a polymer in conjunction with a solid particulate material. The nature of the group members will be disclosed more fully as follows:

Liquid silicone rubbers are well known, and are applied to a suitable substrate though ideally a leather. For use in the present invention, optionally but ideally a cross-linking agent such as an epoxysilane is used. This can enhance wear and durability characteristics as are appropriate for use on a sports shoes.

Leather substrates coated with a liquid silicone rubber substantially improve dry grip performance, and in this regard are a valuable contribution to the prior art. Coefficient of friction values of given in Table 1. However it is seen that, a while a silicone rubber coating still exhibits an improvement in the wet coefficient of friction (over standard athletic leather), its performance enhancement is not to the same as degree as in the dry. Where consistency of performance is required, the coating can be further modified by the inclusion or application of a particulate substance—these being described more fully below. This can improve wet grip, though with some potential loss of dry grip.

A further suitable coating type in the preferred group is highly plasticised coatings. Typically these will be used without the inclusion of particulate materials, though this still remains an option. Preferably these are highly plasticised polymers are from the group comprising: polyvinylchlorides (PVC), soft polyurethanes, silicone rubbers, PVC/PVA (polyvinylacetate) copolymers, or composites thereof. Other polymers which can also be considered and used include: silicone rubbers, urethane resins, acrylic resins, and urethane/acrylic hybrids

In preferred embodiments of highly plasticised coatings the coating includes 25-55% by weight (inclusive) of PVC or PVC/PVA copolymer and a plasticiser within the range 45-75% by weight (inclusive). Other components may also be present, to a total of 100% by weight. Preferably the total plasticiser content is around the 66±4% mark by weight.

Additional plasticisers, i.e. more than one plasticiser, may be present. Preferably, where a secondary plasticiser is used, this may be present so as to at least partially exude to the applied coatings surface so that the surface is cover by a thin film of plasticiser which is virtually self-regenerating. This can improve the gripping properties of an applied coating. Examples of coatings with just primary, as well as primary and secondary, plasticisers will be given later.

Such plasticisers are also typically categorised by being only partly compatible with the polymer to which they are added. Due to this, these plasticisers are less tightly bound and are more able to migrate from within the bulk of the coating to a zone of lower plasticiser concentration—e.g. the applied coating's surface. Certain combinations of primary plasticisers, when combined with certain extenders, can also exhibit this property.

The inclusion of components allowing plasticiser migration can provide certain advantages. Continued migration provides for the continuing presence of a tacky surface layer, even after continued wear or cleaning of the boot. Only a small quantity of plasticiser needs to be present on the surface, so migration rates do not need to be high.

Some preferred plasticisers are given by way of example in the following plasticiser group: modified polyester plasticisers, glycol esters of straight chain di-basic acids, monomeric esters of straight chain dibasic acids with C₄-C₁₄ monohydric alcohols (e.g. monomeric adipates). These plasticisers are also suitable as additional (e.g. secondary) plasticisers.

More specifically, primary or fully compatible plasticisers are tightly bound to the resin and can migrate only slowly within the plasticised resin mass. For reasons of compatibility, raw material cost, in-process behaviour, and performance in various end uses, the families of primary plasticizers suitable for use with PVC are primarily, but not limited to, the following:

Dialkyl adipate esters, dialkyl azelates, some glycol dibenzoate esters, glycollates such as butyl phthalyl, butyl glycollate, mellitates such as trialkyl trimellitates, a few phenoxy compounds, phosphate esters including triaryl, trialkyl and alkyl-aryl combinations, derivatives of ortho-phthalic acid with emphasis on dialkyl and alkyl benzyl o-phthalates, polyesters and various dibasic acids with glycols (e.g., adipic, azelaic and phthalic acids with various glycols terminated with a monofunctional compound), some pentaerythritol derivatives and various sulfonamides.

Secondary or partly compatible plasticisers are less tightly bound and can therefore migrate within the mass from a zone of higher plasticiser concentration to a zone of lower plasticiser concentration. They can also exude to carrying extents to the surface of the plasticised resin. Secondary (extender) plasticizers for use with PVC include, but are not limited to, the following:

Various aromatic and mixed aromatics aliphatic oils, chlorinated paraffins, some poly-alpha methylstyrene derivatives and inexpensive esters of high molecular weight alcohols and organic acids, which have marginal compatibility with PVC, monomeric esters of straight chain dibasic acids, certain epoxy derivatives including epoxidized soybean oil, epoxidized tall oil and some epoxy resins, etc.

Extenders are loosely bound and can migrate freely within the mass, and exude to the surface to a marked degree. They can also be referred in literature also as secondary plasticisers. Examples suitable for inclusion in these embodiments of the present invention include polyisobutylenes.

In preferred embodiments of a highly plasticised coating, the additional components to the polymeric material may include:

i) a primary or fully compatible (with the polymer) plasticiser
ii) a secondary plasticiser which is partly compatible with the polymer
iii) optionally additional plasticisers
iv) optionally extenders, stabilisers or other components.

The additional components (iv) may include stabilisers such as calcium and zinc stearates. In preferred embodiments the ration is in the inclusive weight range of 5:1 to 20:1. This may also be included dispersed in an epoxidised soya bean oil carrier, and which also acts as a stabiliser. A typical preferred proportion of soy bean carrier with stearates is 0.3-2.0% by weight (inclusive) of the entire coating blend, and nominally (in certain preferred embodiments) around 0.52%.

Pigments, dyes, colouring, and reflective components may also be added as desired. Commercial pigments such as available from Clariant GmbH are suitable for most coatings mentioned within this specification.

Application is ideally around 5-15 g/sqft (54-162 g/m²), though may be within the broader inclusive range of 2-35 g/sqft (21-377 g/m²) for shoe and glove applications. Various processes for application of these coatings will be described later.

Also present in the group are synthetic rubber coatings. These are flexible, but in the invention are preferably used in conjunction with a particulate material (see later). Natural rubbers may be considered, though their performance and consistency in manufacturing processes (of the present invention) are typically superseded by synthetic alternatives.

The present invention allows for a range of synthetic rubber materials to be considered, providing they exhibit certain desirable properties in their intended application as a coating material on a sports shoe. These properties include adhesion to the substrate (though priming and substrate surface modifying procedures may be included), flexibility to respond to flexing of the substrate, being able to hold particulate material include rather than letting it easily be released (though this can also be influenced by the choice of particulate matter), wear resistance, and ideally being able to withstand the typical environment to which it will be exposed. Other considerations may also come into play, including the ability to be pigmented or coloured (other than black), and being easily cured during a manufacturing or coating process, etc. Nitrile rubbers can be particularly suitable.

The final coating type in the desired group comprises polymer materials in conjunction with particulate materials. The same general considerations as for synthetic rubbers also apply, and a variety of polymeric materials may be considered for use within the present invention. In particular, however, the inventor has found polyurethane resins to be particularly suitable. Preferred embodiments of the present invention utilise aliphatic polyurethane resins, and optionally (but preferably) one or more cross-linking agents. Preferred cross-linking agents include isocyanates, and in particular (but not restricted to) aliphatic polyisocyanates.

The polymeric coatings (though this can also be applicable to the other coating/binding agents discussed) may optionally also include a variety of other components. These may include, for instance: fillers, binders of varying types, diluents and solvent, pigments, stabilisers, adhesion/priming components, and additional cross-linking or polymer modifying agents, etc. This provides the user of the present invention with additional options to meet specific requirements, without departing from the general invention herein. Some specific and currently preferred examples of the inventor shall be given later.

Preferred particulate materials for use in the present invention ideally possess one or more desirable properties. These include: providing increased grip in areas where the particles are exposed, being of sufficient size to provide an irregular (rather than smooth) outer surface when compounded or embedded in a coating, be compatible with the coating, interact with the coating so that they are substantially retained by the coating during use, and are durable. Ideally also they will, in combination with the coating/binding material, be able to form a flexible surface which will remain adherent to the substrate—typically a leather. Preferably also, they will not significantly alter the flexibility of the substrate—it is not desirable to provide a shoe which is too rigid and cannot provide any feedback that the user may desire. Hence, the particulate and coating system needs to be able to be applied as a relatively thin combination—in stark contrast to thick coatings of anti-slip material which may be used in building construction. Accordingly, the previously mentioned binding/coating materials have been selected by the inventor as being particularly suitable for use in the intended application of the present invention.

The choice of particulate materials may vary, though preferred materials may be roughly categorised into two main groups: particulate mineral materials, and particulate synthetic materials.

The mineral based materials are typically characterised by being crystalline and/or having sharp or jagged edges. Specific materials (by way of example) include: aluminium oxides, tungsten carbide, silicon carbide, cubic boron nitride, ceramic materials, garnet, Trizact®, a micro-replicated engineered abrasive from 3M, and diamond particulates. These may be natural or synthetic in origin. Any one or more may be used in a particulate composition used in conjunction with a coating/binding according to the present invention.

The size of the particulates may ultimately be within the range of 0.001-3000 microns, though 0.5-100 microns or a grit size from 1600-120 may be preferentially used. A mixture of different sizes may be used in conjunction with a coating according to the present invention.

The second group of synthetic materials typically refer to polymeric materials such as plastics and rubbers, both natural and synthetic. These may include hard plastics materials. A preferred example is what is known as ‘crumbed rubber’, which are particulates often manufactured from comminuting rubber materials—such as used tyres. However, particulates based on specially formulated rubbers or polymers may also be used, and can provide increased durability and performance. These may exhibit improved adhesion or bonding with preferred coating materials (particularly urethane and polyurethane materials), and improved hardness (ideally equal or harder to 75 Shore A). They may also be able to be coloured according to user preference. One example of a preferred particulate material of this type are the Soft-sand rubber particulates currently marketed by Soft-Point Industries Inc. of Paxton, Mass., USA. These types of materials can be combined with the mineral particulate materials above.

Incorporation of particulate materials into coating/binding systems, according to the present invention, preferentially follow two methods (or a combination thereof). This includes surface application of particulate material to an applied coating. The second method is to incorporate the particulate material into the coating for application. Each provides certain advantages and disadvantages—exposed aggregate being more susceptible to loss from the coating from repeated wear, but providing higher coefficients of friction.

Within the present invention is also a repair formulation which may be applied to areas of the shoe by a user to repair areas of high use, or to change its specific characteristics. These ‘painted’ on coatings will tend not to be as durable as the preferred embodiments of the present invention, but provide a useful enhancement. Typically these will comprise a particulate material within a suitable coating binder system, which may comprise a polyurethane material (e.g. an aqueous aliphatic polyurethane), optionally also including acrylic binder (e.g. an aqueous aliphatic acrylic dispersion), though will also be formulated to satisfactorily bond to the particular coating type (of the present invention) over which it is to be applied. Medium to large particulate sizes will preferably be used. The user applied over-coating represents an alternative to patch type embodiments (see below), though are preferably used over previously coated substrates according to the present invention.

For the majority of the preferred coatings and materials the observable coefficient of friction when wet is reasonably comparable to the coefficient of friction when dry. This is preferable for performance consistency in changing conditions.

According to the present invention, the entire upper need not comprise the same type of gripping regions, but may do if desired. Accordingly, selective areas may comprise gripping regions of different types, some comprising different coefficients of friction under wet or dry conditions. For instance, some areas may be optimised for wet weather performance, while another may be optimised for dry weather performance. This may comprise a leather or other material coated with various coatings according to the present invention.

The upper, in such cases, may be manufactured from different sections of materials possessing different characteristics. However, some treatment and coating methods can lend themselves to a number of options. For instance, a sheet of material could be selectively coated with different treatments or coatings so that its surface characteristics (notably coefficient of friction) will vary across the surface. The upper can then be made in part, or full, from such a sheet.

Areas of such a sheet can be coated or treated in different manners. The different regions may comprise visual material such as text, graphics, logos, or other marketing material. Another variation is patterned regions which enhance performance of the shoe, or which enhance certain player characteristics. Such possibilities provide quite significant potentially realisable advantages to both players and shoe manufacturers.

Also within the scope of the invention are patches that may be applied to shoes to provide certain advantages of the present invention such as increased wet grip. Typically these patches will provide a substrate and an outer surface. The outer surface may be a coating applied to a substrate, though may be merely the outer surface of the substrate. Ideally the outer surface will have improved dry grip characteristics according to what has been discussed above. Hence the substrate and outer could comprise a piece of treated leather material, or any of the other previously mentioned material options.

The underside may include an adhesive coating. This may be permanent or non-permanent adhesive, which would allow patches to be used temporarily or readjusted in position. A removable protective cover may be provided over the adhesive back.

The underside may not include adhesive but may be suitable for the application of an adhesive material. This would allow the use of different adhesives to be chosen, and might be used on patches applied during manufacture or by a shoe repairer or other suitably qualified person. The underside may be absorbent, keyed, or otherwise modified to improve adhesion.

Other types of fastening may be provided for attaching the patch. For instance, hook and pile fasteners, such as Velcro®, may be considered.

Also, the upper of the shoe may be fully or partially made of a synthetic material having good coefficient of friction characteristics. This includes various microhook or micropile materials may be used. One such material is Greptile® G200 though other comparable materials may be considered.

By way of example, some representative data for different materials tested by the inventor follows.

| | WET coefficient | DRY coefficient |
|---|---|---|
| Material | of friction | of friction |
| Std athletic leather | 0.3 | 0.8 |
| Textured leather | 0.8 | 1.7 |
| Greptile ® G200 | 3.4 | 3.5 |
| Rubberised particulate coating | 1.5 | 2.0 |
| Abrasive particulate coating | 3.6 | 3.9 |
| High plasticiser coating | 1.6 | 11.0 |
| Silicone rubber coating | 1.4 | 9.8 |

Testing according to modified IUP51 of Intl Union of Leather Technologists & Chemists.

As can be appreciated there are many variations to the present invention, and ways by which it may be implemented. Some specific embodiments will now be described, by way of example.

### DESCRIPTION OF DRAWINGS

FIG. 1 is a perspective diagrammatic view of one preferred embodiment of a sports shoe according to the present invention, and

FIG. 2 is a perspective diagrammatic view of a preferred embodiment of a patch according to the present invention.

### DESCRIPTION OF PREFERRED EMBODIMENTS

### Example 1

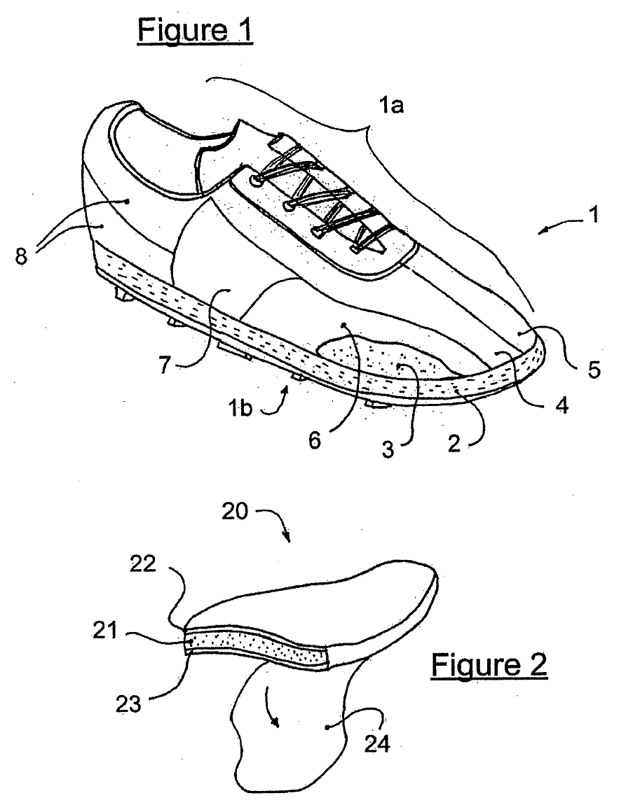

A preferred embodiment of the invention is illustrated in FIG. 1. This embodiment includes a number of possible features of the invention including grip areas of different types.

FIG. 1 illustrates a soccer boot (1). There is generally indicated an upper (1a) and a sole (1b). The sole may be of standard construction for the type of shoe or boot.

The upper comprises sections of different materials stitched together, though other methods of construction can be implemented. For simplicity, we shall refer to common stitched construction in this example.

A lower section (2) near the sole comprises a rubberised/particulate coated leather material. Adjacent section (3) comprises a patch of a resinous particulate coated material, which has been adhesively applied to customise the boot for the player.

Front sections (4) and (5) are a leather material in which a rubberised particulate coating has been selectively applied in a repeating pattern comprising the manufacturers logo. Consequently there are areas of enhanced dry grip distributed over the surfaces of these sections.

Sections (6) and (7) comprise dry grip sections of a material such as Greptile® (G200 which has reasonable wet grip characteristics as well as dry grip.

The rear portion (8) may be of various materials according to user choice.

It should be noted that this represents just one possible application of the present invention out of many. Not all sports shoes need be constructed in this way, nor include as many different aspects of the invention.

### Example 2

FIG. 2 illustrates a patch (20) according to the present invention shown partly in cross-section though the dimensions have been exaggerated. There is provided a substrate (21) of a thin leather material to which a rubberised particulate coating has been applied to provide an upper surface (22) of enhanced dry grip characteristics.

The underside (23) comprises an adhesive material overlaid with a removable protective backing (24).

In practice the patch can be trimmed to shape, if needed, and adhered to the outer surface of a shoe where required. As variations, adhesives able to adhere to damp or wet surfaces may be employed, allowing application to a damp shoe during a game. Also, pre-contoured patches may be available, which are contoured in 3-dimensions to fit over contoured regions of a shoe such as the tip of the toe portion.

### Example 3

### Abrasive Particulate Coating

Abrasive particulates of the following types can be used in this example:
a) Aluminium Oxide
b) Tungsten Carbide
c) Silicon Carbide
d) Cubic Boron Nitride
e) Ceramic materials
f) Garnet (a naturally occurring abrasive)
g) “Trizact”™ micro-replicated engineered abrasive from 3M
h) Diamond particulates

These are representative of preferred particles which are ideally non-spherical, but are shaped (either irregularly or by synthetic means) to provide a hard and sharp edge. Generally these particulates range from 0.5-100 microns in size, although a range of 0.001-3000 microns can be used or this can be grit size from size 1600-120. These particulates are attached to the surface of the substrate, e.g. leather, by means of a tough yet flexible film to ensure that the particulates do not become torn away easily during wear. In addition it is best if the coatings that are used to anchor the particulate materials are stable to water and or solvents—especially water, as shoes/boots will be worn during both wet and dry conditions. Preferred coatings include acrylic, urethane and epoxy based materials, generally crosslinked, (e.g. polyisocyanate) to enhance the water resistance and toughness of the film. Ultimately the surface can be left as this or recoated again with a toughened binder system for improved longevity.

A suitable method is described, although there are other variants:

### Method 1:

A substrate material, e.g. leather, is passed through a roller-coater machine whereby a crosslinked urethane resin is applied. Typically the coat weight of the resin will be between 8-14 g per square foot, but more or less can be applied. Such a resinous mix may be comprised of approximately the following:

| | |
|---|---|
| 10 Parts | Aliphatic Polyisocyanate (Crosslinker) |
| 15 Parts | Aqueous dispersion of an inorganic matting agent together |
| | with proteins, fats and special colloids (Filler) |
| 35 Parts | Aqueous Aliphatic Polyurethane dispersion (Binder) |
| 20 Parts | Aqueous Aliphatic Acrylic dispersion (Binder) |
| 20 Parts | Water (Diluent) |

The above mix may be coloured with pigment if so desired.

After the mix has been applied to the surface of the leather, but before drying/curing, abrasive particulates (such as those listed above) are applied to the surface of the leather. This can be exclusive use of one type of abrasive particulate, or indeed blends to form enhanced or synergistic combinations. For example, but not limited to, this can be achieved by means of a vibration type applicator or a rotary applicator, set to deliver a specific amount of particulate. Generally this would be between 5-10 g per sq ft, but can range from 0.1 g-50 g per square foot of surface area, depending on the desired effect. The surplus particulate being applied whilst there is a gap between skins passing through the conveyor may be caught in a recycling bin for reuse. There is an option to electromagnetically align these particulates as is common in the preparation of abrasive paper, but this is dependent upon whether the abrasive particulate has been chemically modified to be affected by charge.

The leather then passes through a curing unit. Generally this is simply through heating the leather along a drying line to reach temperatures of approximately 100° C. for 2-3 minutes. However, the curing system will be dependent entirely upon the resin binder system being used, e.g. UV curing, radiation curing, etc.

As an option, after the binder-particulate blend is cured, an optional further binder coat can be applied as a top coat. This has the effect of further strengthening the film matrix holding the particulate and ensuring maximum durability. Applications will most likely use a similar formulation to that stated above, but application levels will be less, optimally 4-8 g per square foot, and will most likely be sprayed for ease of application, with the use of an automatic spray line. Again curing is dependent upon the binder system used.

Other application methods may attempt to disperse the abrasive particulate in the resinous mix and apply in a different manner, e.g. a curtain coating system, knife over air system, by brush etc. The coating may also be applied as a pattern, rather than as a continuous coating—if desired. Important to this method is to gain adequate dispersion and keep the particulates well suspended. High speed shear mixers are used for this.

### Example 4

### Rubberised Particulate Coating

Rubberised particulates of the following types can be used in this example:
a) Rubberised sand
b) Crumbed rubbers

These particulates can either be spherical, elliptical or irregular in shape. The rubberised surface creates a high coefficient of friction. Rubberised sand called SandSoft® (see previously) is available from Soft.Point Industries Inc. Crumbed rubbers to user specifications may be ordered from different sources. Generally these particulates range from 0.5-100 microns in diameter size, although a range of 0.001-1000 microns can be used. These particulates must be attached to the surface of the substrate material, e.g. leather, by means of a tough but flexible film to ensure that the particulates do not become torn away easily during wear. In addition it is best if the coatings that are used to anchor the particulate materials are stable to water and or solvents—especially water as shoes/boots will be worn during both wet and dry conditions. Preferred coatings include acrylic, urethane and epoxy based materials, generally crosslinked, e.g. polyisocyanate, to enhance water resistance and toughness of the fin. Ultimately the surface can be left as this or recoated again with a toughened binder system for improved longevity.

Two suitable methods are described, although there are many other variants:

### Method 1:

A substrate material, e.g. leather, is passed through a roller-coater machine whereby a crosslinked urethane resin is applied. Typically the coat weight of the resin will be between 8-14 g per square foot, but more or less can be applied. Such a resinous mix will be comprised of the following:

| | |
|---|---|
| 10 Parts | Aliphatic Polyisocyanate (Crosslinker) |
| 15 Parts | Aqueous dispersion of an inorganic matting agent together |
| | with proteins, fats and special colloids (Filler) |
| 35 Parts | Aqueous Aliphatic Polyurethane dispersion (Binder) |
| 20 Parts | Aqueous Aliphatic Acrylic dispersion (Binder) |
| 20 Parts | Water (Diluent) |

The above mix may be coloured with pigment if so desired.

After the mix has been applied to the surface of the leather, but before drying/curing, rubberised particulates (such as those listed above) are applied to the surface of the leather. This can be exclusive use of one type of rubberised particulate, or indeed blends to form synergistic compounds. For example, but not limited to, this can be achieved by means of a vibration type applicator or a rotary applicator, set to deliver a specific amount of particulate. Generally this would be between 5-10 g per sq ft, but can range from 0.1 g-50 g per square foot of surface area, depending on the desired effect Surplus particulate falling in the gap between skins passing through the conveyor can be caught in a recycling bin for reuse.

The leather then passes through a curing unit. Generally this is simply through heating the leather along a drying line to reach temperatures of approximately 100° C. for 2-3 minutes. However, the curing system will be dependent entirely upon the resin binder system being used, e.g. UV curing, radiation curing, etc.

As an option, after the binder-particulate blend is cured, an optional further binder coat can be applied as a top coat. This has the effect of further strengthening the film matrix holding the particulate and ensuring maximum durability. Applications will most likely use a similar formulation to that stated above, but application levels will be less, optimally 4-8 g per square foot, and will most likely be sprayed for ease of application, with the use of an automatic spray line. Again curing is dependent upon the binder system used.

### Method 2:

A substrate material, e.g. leather, is passed through a standard roller-coater machine whereby a crosslinked urethane resin is applied which contains the rubberised particulate dispersed in it. Typically the coat weight of the resin will be between 8-14 g per square foot, though more or less can be applied according to user preference. Such a resinous mix will be comprised of the following:

| | |
|---|---|
| 10 Parts | Aliphatic Polyisocyanate (Crosslinker) |
| 10 Parts | Aqueous dispersion of an inorganic matting agent together |
| | with proteins, fats and special colloids (Filler) |
| 25 Parts | Aqueous Aliphatic Polyurethane dispersion (Binder) |
| 20 Parts | Aqueous Aliphatic Acrylic dispersion (Binder) |
| 10 Parts | Water (Diluent) |
| 25 Parts | Rubberised particulate |

The above mix may be coloured with pigment if so desired. The mix will require high speed shear mixing in order to gain adequate particle dispersion within the mix. Optionally additional auxiliaries may be added that enhance dispersing properties, simply know as dispersants.

The leather then passes through a curing unit. Generally this is simply through heating the leather along a drying line to reach temperatures of approximately 10° C. for 2-3 minutes. However, the curing system will be dependent entirely upon the resin binder system being used, e.g. UV curing, radiation curing, etc.

As an option, after the binder-particulate blend is cured, an optional further binder coat can be applied as a top coat. This has the effect of further strengthening the film matrix holding the particulate and ensuring maximum durability. Applications will most likely use a similar formulation to that stated above, but application levels will be less, optimally 4-8 g per square foot, and will most likely be sprayed for ease of application, with the use of an automatic spray line. Again curing is dependent upon the binder system used.

### Example 5

### Highly Plasticised Coating

Essentially the coating is a highly plasticised compound of a:
a) PVC homopolymer
b) PVC/PVA copolymer
c) Silicone rubber
d) Urethane resin
e) Acrylic resin
f) Urethane/Acrylic hybrid

Additional crosslinking auxiliaries (e.g. polyisocyanate) may be employed to gain improved physical properties of the film for wear characteristics during use. In addition, this compound can be enhanced by the introduction of abrasive or rubberised particulates in similar fashions as described earlier.

A suitable method is described, although there are many other variants:

### Method 1:

A substrate material, e.g. leather, is passed through a roller-coater machine whereby a highly plasticised PVC is applied. Typically the coat weight of the mixture will be between 8-14 g per square foot, but more or less can be applied. Such a mix can be comprised of the following:

| | |
|---|---|
| 65 Parts | Plasticiser |
| 35 Parts | PVC homopolymer |

The above mix may be coloured with pigment if so desired.

The leather then passes through a curing unit. Generally this is simply through heating the leather along a drying line to reach temperatures of approximately 165° C. for 2-3 minutes. However, the curing system will be dependent entirely upon the chemical character of the mixture being used, e.g. UV curing, radiation curing, etc.

Further coats can be applied if necessary by any coating method desired, followed once again by correct curing conditions. The coating can optionally be embossed by various means, e.g. a texture embossing plate, to put a texture into the surface which can help improve the wet grip characteristics. This can also be considered for many of the other examples herein.

### Example 5a

### Highly Plasticised PVC Coating with Primary Plasticiser Only

33 Parts Polyvinyl chloride resin

### 64 Parts Di-Octyl Phthalate (CAS No [117-81-7])

### 2 Parts Pigment

1 Part Calcium/zinc stearate dispersion (in expoxidised soya bean oil as stabiliser)

Parts are by weight and may vary slightly from the exact formulation of this example. The coating may be applied by the methods given above in relation to Example 5.

### Example 5b

### Highly Plasticised PVC Coating with Primary and Secondary Plasticiser

33 Parts Polyvinyl chloride resin

### 32 Parts Di-Octyl Phthalate (CAS No [117-81-7])

32 Parts Epoxidized soybean oil

### 2 Parts Pigment

1 Part Calcium/zinc stearate dispersion (in expoxidised soya bean oil as stabiliser)

Parts are by weight and may vary slightly from the exact formulation of this example. The coating may be applied by the methods given above in relation to Example 5.

### Example 5c

### Highly Plasticised PVC Coating which Includes Extender

33 Parts Polyvinyl chloride resin

### 55 Parts Di-Octyl Phthalate (CAS No [117-81-7])

### 9 Parts Polyisobutylene

### 2 Parts Pigment

1 Part Calcium/zinc stearate dispersion (in expoxidised soya bean oil as stabiliser)

Parts are by weight and may vary slightly from the exact formulation of this example. The coating may be applied by the methods given above in relation to Example 5.

### Example 6

### Liquid Silicone Rubber Coating

Here a liquid silicone rubber coated onto the surface of leather. Additional crosslinking auxiliaries (e.g. epoxysilanes) may be employed to gain improved physical properties of the film for wear characteristics during use. In addition, this compound can be enhanced by the introduction of abrasive or rubberised particulates in similar fashions as described earlier.

A suitable method is described, although there are other variants:

### Method 1:

Leather is passed through a roller-coater machine whereby a liquid silicone rubber is applied. Typically the coat weight of the mixture will be between 8-14 g per square foot, but more or less can be applied. Such a mix will be comprised of the following:

| | |
|---|---|
| 97 Parts | Liquid silicone Rubber |
| 3 Parts | Epoxysilane cross-linker |

The above mix may be coloured with pigment if so desired.

The leather then passes through a curing unit. Generally this is simply through heating the leather along a drying line to reach temperatures of approximately 165° C. for 2-3 minutes. However, the curing system will be dependent entirely upon the chemical character of the mixture being used, e.g. UV curing, radiation curing, air curing, etc.

Further coats can be applied if necessary by any coating method desired, followed once again by correct curing conditions. Embossing can also be considered—see also above.

### Example 7

### Patch

The patch is in essence cut out components of the prior types of coated material described above. The base material is either a natural or synthetic fibre that is either woven or non-woven, e.g. all leather types, including goat or kangaroo, or a synthetic such as Kevlar.

Generally the thickness of the base material will be 0.6-1.0 mm in thickness, although may range from 0.1-2 mm in thickness.

Adhesives used can be:
a) Liquid rubber adhesive
b) Superglue type adhesive (Cyanoacrylate)
c) High tack adhesives used in wound dressings
d) Hook and loop fastening (e.g. Velcro)
e) Double sided tape
f) Pressure sensitive adhesive
g) Repositional adhesives
h) Acrylic based adhesives
i) Urethane based adhesives

Theses adhesives are suggestion for both permanent and removable patches to be added. And hydrolytic (water stable) adhesives are suggested due to the end use.

Aspects of the present invention have been described by way of example only and it should be appreciated that modifications and additions may be made thereto without departing from the spirit or scope of the present invention as defined in the appended claims.

It should also be understood that the term “comprise” where used herein is not to be considered to be used in a limiting sense. Accordingly, ‘comprise’ does not represent nor define an exclusive set of items, but includes the possibility of other components and items being added to the list.

This specification is also based on the understanding of the inventor regarding the prior art. The prior art description should not be regarded as being authoritative disclosure on the true state of the prior art but rather as referencing considerations brought to the mind and attention of the inventor when developing this invention.

1-38. (canceled)

39. A shoe, in which at least a portion of the upper includes gripping areas resulting from the presence of a coating, said coating providing a dry co-efficient of friction exceeding that of standard athletic leather according to the modified IUP51 test defined herein.

40. A shoe as claimed in claim 39, in which said coating comprises a liquid silicone rubber coating.

41. A shoe as claimed in claim 39, in which said coating comprises a highly plasticised coating.

42. A shoe as claimed in claim 41, in which said coating is based on a PVC homopolymer or PVC/PVA copolymer.

43. A shoe as claimed in claim 42, in which there is included a plasticiser from the group comprising: Dialkyl adipate esters, dialkyl azelates, glycol dibenzoate esters, glycollates such as butyl phthalyl, butyl glycollate, mellitates such as trialkyl trimellitates, a few phenoxy compounds, phosphate esters including triaryl, trialkyl and alkyl-aryl combinations, derivatives of ortho-phthalic acid with emphasis on dialkyl and alkyl benzyl o-phthalates, polyesters and various dibasic acids with glycols (e.g., adipic, azelaic and phthalic acids with various glycols terminated with a monofunctional compound), pentaerythritol derivatives and sulfonamides.

44. A shoe as claimed in claim 43, in which there is included a secondary plasticiser from the group comprising: aromatic and mixed aromatics aliphatic oils, chlorinated paraffins, poly-alpha methylstyrene derivatives and esters of high molecular weight alcohols and organic acids, which have marginal compatibility with PVC, monomeric esters of straight chain dibasic acids, certain epoxy derivatives including epoxidized soybean oil, epoxidized tall oil and some epoxy resins.

45. A shoe as claimed in claim 43 in which the amount of plasticiser(s) present is 45% or more by weight compared to the polymer or co-polymer.

46. A shoe as claimed in claim 43 in which the amount of plasticiser(s) present is 66±4% by weight compared to the polymer or co-polymer.

47. A shoe as claimed in claim 43 which includes a mineral stearate dispersed in an epoxidised soya oil.

48. A shoe as claimed in claim 43 which includes a polyisobutylene.

49. A shoe as claimed in claim 43 which either or both, include or are at least partially coated with a particulate material.

50. A shoe as claimed in claim 39 which is at least partially coated with a coating and which either or both includes a particulate material, or has had a particulate material applied.

51. A shoe as claimed in claim 50 in which the coating includes either or both an aqueous aliphatic polyurethane dispersion and aqueous aliphatic acrylic dispersion.

52. A shoe as claimed in claim 51 which includes a cross-linking agent.

53. A shoe as claimed in claim 52 in which the cross-linking agent is an isocyanate.

54. A shoe as claimed in claim 50 in which the particulate material includes any one or more of: a mineral, a crumbed rubber, or a synthetic plastic material in a particulate or granular form.

55. A shoe as claimed in claim 54 in which the mineral is selected from the group comprising: aluminium oxides, tungsten carbide, silicon carbide, cubic boron nitride, ceramic materials, garnet, a Trizact® abrasive from 3M, and diamond particulates.

56. A shoe as claimed in claim 54 in which the hardness of included plastic particles equals or exceeds a hardness of 75 Shore A.

57. A shoe as claimed in claim 54 in which said particulate material includes particles in the size range of 0.5-100 microns inclusive.

58. A shoe as claimed in claim 41 when a said coating is applied to a leather material.

59. A shoe as claimed in claim 58 in which the leather is goat or kangaroo leather.

60. A shoe as claimed in claim 41 in which a said coating is applied to a fabric or textile.

61. A shoe as claimed in claim 60 in which the fabric or textile is, or includes, a polyamide fibre material.

62. A shoe as claimed in claim 41 in which a said coating has been applied in a pattern.

63. A shoe as claimed in claim 62 in which the pattern comprises one or more of: logos, advertising material, graphics, text, alphanumeric characters, repetitive patterns or arrangements.

64. A shoe as claimed in claim 41 which includes areas comprising different of said coatings.

65. A shoe as claimed in claim 39 which includes an area of the hook and pile material Greptile G200 by 3M.

66. A sports shoe in which at least part of the upper in the toe area possesses a coating of a grip enhancing agent which increases the dry coefficient of friction, when compared to standard athletic leather when measured by a modified IUP51 test as defined herein, said grip enhancing agent being selected from the group comprising: liquid silicone rubbers, PVC polymers with high plasticiser contents, PVC/PVA copolymers with high plasticiser contents, urethane resins with high plasticiser contents, acrylic resins with high plasticiser contents, urethane/acrylic blends or hybrids with high plasticiser contents, particulate materials in combination with previously listed members of this group, and particulate materials in combination with acrylic and/or polyurethane binders.

67. A patch suitable for attachment to a shoe in which at least part of said patch possesses a coating of a grip enhancing agent which increases the dry coefficient of friction, when compared to standard athletic leather when measured by a modified IUP51 test as defined herein, said grip enhancing agent being selected from the group comprising: liquid silicone rubbers, PVC polymers with high plasticiser contents, PVC/PVA copolymers with high plasticiser contents, urethane resins with high plasticiser contents, acrylic resins with high plasticiser contents, urethane/acrylic blends or hybrids with high plasticiser contents, particulate materials in combination with previously listed members of this group, and particulate materials in combination with acrylic and/or polyurethane binders.

68. A patch as claimed in claim 67 in which one or more plasticiser in a grip enhancing agent including a high plasticiser content is selected from the group comprising: Dialkyl adipate esters, dialkyl azelates, glycol dibenzoate esters, glycollates such as butyl phthalyl, butyl glycollate, mellitates such as trialkyl trimellitates, a few phenoxy compounds, phosphate esters including triaryl, trialkyl and alkyl-aryl combinations, derivatives of ortho-phthalic acid with emphasis on dialkyl and alkyl benzyl o-phthalates, polyesters and various dibasic acids with glycols (e.g., adipic, azelaic and phthalic acids with various glycols terminated with a monofunctional compound), pentaerythritol derivatives and sulfonamides.

69. A patch as claimed in claim 67 which has a self-adhesive layer on one side for adhesion to the upper of a shoe.

70. A material suitable for the manufacture of at least part of the upper of a shoe in which said material possesses a coating of a grip enhancing agent which increases the dry coefficient of friction, when compared to standard athletic leather when measured by a modified IUP51 test as defined herein, said grip enhancing agent being selected from the group comprising: liquid silicone rubbers, PVC polymers with high plasticiser contents, PVC/PVA copolymers with high plasticiser contents, urethane resins with high plasticiser contents, acrylic resins with high plasticiser contents, urethane/acrylic blends or hybrids with high plasticiser contents, particulate materials in combination with previously listed members of this group, and particulate materials in combination with acrylic and/or polyurethane binders.

71. A material as claimed in claim 70 in which one or more plasticiser in a grip enhancing agent including a high plasticiser content is selected from the group comprising: Dialkyl adipate esters, dialkyl azelates, glycol dibenzoate esters, glycollates such as butyl phthalyl, butyl glycollate, mellitates such as trialkyl trimellitates, a few phenoxy compounds, phosphate esters including triaryl, trialkyl and alkyl-aryl combinations, derivatives of ortho-phthalic acid with emphasis on dialkyl and alkyl benzyl o-phthalates, polyesters and various dibasic acids with glycols (e.g., adipic, azelaic and phthalic acids with various glycols terminated with a monofunctional compound), pentaerythritol derivatives and sulfonamides.
